(19) United States
(12) Patent Application Publication
(10) Pub. No.: US 2005/0172857 A1
(43) Pub. Date: Aug. 11, 2005

(54) Model material for dental applications

(76) Inventor: Volker Winter, Karlsruhe (DE)

Correspondence Address: NATH & ASSOCIATES, 1030 15th STREET, NW, 6TH FLOOR, WASHINGTON, DC, 20005, US

(21) Appl. No.: 10/520,845

(22) PCT Filed: Jul. 5, 2003
(86) PCT No.: PCT/EP03/07204

(30) Foreign Application Priority Data
Jul. 12, 2002 (DE) 102 32 135.3
Dec. 23, 2002 (EP) 02028902.1

(51) Int. Cl. C09K 3/00; B28B 7/36

(52) U.S. Cl. 106/35; 106/272; 106/38.2; 106/38.25

(57) ABSTRACT

A modeling material for dental purposes comprises at least one metal and/or at least one metal compound which are able to react chemically with one another and/or with at least one further reactant so as to lead to an increase in volume, and at least one substance having thermoplastic and/or wax-like properties. If desired, a glass-ceramic, a glass and/or an oxide-ceramic material and, if desired, an additive, in particular a dispersant, can additionally be present. The modeling material is particularly suitable for compensating for the sintering shrinkage which occurs in the production of ceramic shaped dental parts.

The invention relates to a modeling material for dental purposes, a process for preparing it and its use.

Ceramic or “porcelain” was always an attractive material for producing artificial teeth having a very tooth-like appearance in terms of shape and color. Ceramic is a chemically resistant, corrosion-resistant and biocompatible material which, in addition, is available in virtually unlimited amounts in mineral form and is thus inexpensive. Individual tooth replacement can be produced simply and reproducibly from this material by means of the techniques of a dental technician, so that “dental ceramics” have become established as a material.

To overcome the only weakness of this material, viz. the brittleness, tooth replacement manufactured by dental techniques has generally been produced for a long time as a classical composite material, i.e. as cermet. A cermet crown or bridge comprises a metal framework or substructure and a facing of dental ceramic which reproduces the shape of the tooth. To install the tooth replacement, the substructure is fastened directly on the remaining part of the tooth after preparation by the dentist and is often referred to as (protective) cap. Depending on the material or alloy of which the caps consist and, depending on the production method (casting, electroforming, i.e. electrodeposition), problems in the form of corrosion and resulting discoloration, incompatibility with the body, etc, can arise. There has therefore been increasing development in recent years of systems which can produce comparable substructures of ceramic material and process them further by the techniques of a dental technician.

There are already a number of functioning systems on the dental market. Thus, the ceramic caps are, for example, produced by manual application of a slip to a model stump, subsequent sintering and infiltration with special glass (VITA In-Ceram) or by means of a hot pressing process (Empress, IVOCLAR). There are also systems in which the caps are digitally milled from sintered or presintered ceramic blocks (DCS-System, CEREC, etc). However, it is generally the case that none of the all-ceramic systems mentioned achieve the accuracy of fit of metallic bodies on the remainder of the tooth, regardless of whether the metallic bodies have been cast or formed by electrodeposition processes. In addition, these systems are usually very expensive to purchase.

The lack of accurate fit of existing all-ceramic systems is mainly due to the shaping methods used. Metallic caps are produced by casting or electrodeposition, so that the metal in molten or dissolved form can optimally match the stump geometry. On the other hand, in the case of, for example, CADCAM all-ceramic methods, a solid material has to be milled with removal of material according to a digitally recorded data set. However, scanning of the tooth stump and the milling can, depending on the digital resolution of the system components, itself contain inaccuracies.

A further fundamental difficulty with all existing or future systems for producing all-ceramic tooth replacement from sintered ceramic materials with regard to the accuracy of fit of the finished parts is ceramic shrinkage, i.e. the volume shrinkage of shaped ceramic parts associated with the densifying sintering process. Although this sintering shrinkage can be reduced to a certain extent, it cannot be avoided completely. For this reason, the sintering shrinkage associated with the sintering step is, for example, avoided indirectly by processing previously sintered ceramic (CADCAM method, see above) or seeking to achieve a pore-free solid microstructure in another way (glass infiltration of the soft, porous ceramic cap in the InCeram method, see above). In the case of electrophoretic deposition of ceramic particles, too, the shaped ceramic part obtained subsequently has to be sintered, so that the indicated problem of sintering shrinkage also arises here.

DE-C1-197 03 032 and DE-A1-100 44 605 describe compositions of hot casting compounds and their use for producing corresponding sintered bodies. However, what is described in the first of these texts is the production of sheet-like ceramic or powder-metallurgical components which are structured on one side, for example cooling elements or substrates for electronic components. Although DE-A-100 44 605 does mention that tooth replacement can be produced using the molding compositions claimed, it is not concerned with the abovementioned production of ceramic tooth replacement using dental models (stump models).

DE-A1-4324438 describes a process for producing oxide-ceramic tooth replacement pieces in which the sintering shrinkage is prevented directly during sintering by addition of particles of readily oxidizable metals, metal suboxides or metal hydrides. However, since this process does not use dental models (stump models), it cannot be applied to the above-described applications. An analogous situation applies in the case of DE-C1-195 47 129. There too, the sintering shrinkage of the sintered ceramic body is supposed to be prevented directly during sintering.

It is therefore an object of the invention to help make it possible to achieve a high accuracy of fit of all-ceramic shaped dental parts with the base structures for which they are intended. In particular, the disadvantageous effects of the sintering shrinkage indicated should be avoided.

This object is achieved by the modeling material having the features of claim 1, by the processes of claim 26 and claim 28 and by the use claimed in claim 27. Preferred embodiments are described in the dependent claims 2 to 25 and 29 and 30, respectively. The wording of all claims is hereby incorporated by reference into the present description.

The modeling material of the invention for dental purposes comprises at least one metal and/or at least one metal compound and at least one substance having thermoplastic and/or wax-like properties. The metal and/or the metal compound are, according to the invention, able to react chemically with one another and/or with at least one further reactant so as to lead to an increase in volume. Preference is given to the metal and/or the metal compound forming a first component within the material and the thermoplastic/wax-like substance forming a second component.

The modeling material described has the advantage that it is expandable (due to the ability of the chemical reaction to be carried out). This expandability can be adjusted within wide limits, as explained in more detail below. The sintering shrinkage occurring during the actual production of the shaped ceramic dental part can in this way be taken into account as early as the production of the dental model (for example working model). For this purpose, the expandability of the modeling material is defined and set according to the (known) sintering shrinkage of the ceramic material used for producing the tooth replacement. In this way, shaped dental parts which precisely fit the preparation in the mouth (e.g. tooth stump) or prosthetic buildup parts can be produced.

The composition of the material of the invention can in principle be chosen at will as long as an appropriate increase in volume is possible as a result of some chemical reaction. However, the composition is preferably chosen so that it is possible to carry out a chemical reaction in which an increase in the oxidation number of the metal or of the metal of the metal compound occurs. Such an increase in the oxidation number is, as is known, a possible definition of the term “oxidation”. It therefore includes not only a reaction with oxygen, i.e. an oxidation in the relatively narrow sense, but also, for example, a nitridation.

In further preferred embodiments of the modeling material of the invention, its composition is chosen so that a chemical reaction with an oxygen-containing compound as other reactant or preferably with oxygen as other reactant is possible. Such a chemical reaction can therefore occur in the simplest way by reaction with atmospheric oxygen. The chemical reaction then corresponds precisely to the abovementioned “classical” definition of oxidation.

The metal or the metal of the metal compound can, according to the invention, advantageously be a transition metal. Within this group, particular mention may be made of the transition metals of the fourth transition group, with titanium being particularly preferred.

In further preferred embodiments of the modeling material of the invention, the metal compound is the compound of a metal with (at least one) nonmetal. In such cases, the modeling material therefore does not contain any intermetallic compounds, i.e. no chemical compounds made up of two or more metallic elements. The modeling material in such cases preferably comprises nitrides, carbides or borides as metal compounds, with preference being given to using nitrides. The compounds mentioned are preferred because, inter alia, they can frequently readily be reacted chemically with oxygen/atmospheric oxygen to produce a volume expansion.

According to the invention, all substances having thermoplastic and/or wax-like properties can in principle be used. The definition of such substances is known to those skilled in the art; additional reference may be made, for example, to the definitions in Römpp-Lexikon, Georg Thieme Verlag. For the purposes of the invention, these substances serve to provide processibility and moldability of the metals/metal compounds which are generally in powder form. The substances concerned are preferably waxes, with the modeling material of the invention comprising in particular at least one paraffin wax. Depending on the composition, the modeling material of the invention can become solid at very different temperatures. Owing to the indicated use of these modeling materials, it is, however, preferred that the material has a solidification point in the range from 50° C. to 80° C., in particular from 55° C. to 70° C. Advantages resulting therefrom will be addressed later in connection with the preferred storage form of the modeling material.

Furthermore, the consistency and in this context the viscosity of the modeling material can be set with a view to its use. Since it is usual to fill negative molds of a tooth preparation or a prosthetic buildup part with the modeling material, the modeling material should have a flow limit and have a comparatively low viscosity above the solidification point. Above the solidification point and above the flow limit, it can flow readily and quickly into the appropriate molds. After cooling to temperatures significantly below the solidification point, the modeling material is solid enough to be demolded (i.e. removed from the model) without becoming deformed. On renewed heating of the demolded modeling material to above the solidification point but without overcoming the flow limit, its shape is retained. However, the flow limit is ideally not too high, so that the user of the material, i.e. generally a dental technician, can overcome it by means of simple measures such as stirring with a spatula or use of a vibrator.

In the case of further, preferred embodiments, the modeling material of the invention further comprises at least one glass-ceramic, a glass or an oxide-ceramic material. Glasses are, as is known, quite generally substances in the amorphous, noncrystalline solid state, which can be described physically as a frozen, supercooled melt. Glass-ceramics are polycrystalline solids which are produced by controlled crystallization (devitrification) of glasses. The microstructure of glass-ceramics display both crystalline phases and glass-like, amorphous phases. Oxide-ceramic materials are ceramic materials which comprise (highly refractory) oxides and can also be made up of a plurality of oxides. They have a microstructure which is free of glass phases. According to the invention, the materials mentioned are, in particular, used as constituent of the first component defined at the outset. They are generally inert in respect of the chemical reaction serving to produce the increase in volume, i.e. they reduce the expandability of the modeling material if they are added to it. The materials mentioned are preferably a glass-ceramic derived from silicate glass, silicate glass or an aluminum oxide ceramic. These materials are available in large quantities at a low price.

In further, preferred embodiments of the invention, the modeling material further comprises at least one additive, in particular one or more dispersants. These promote the mixing of the metal/metal compound with the thermoplastic/wax-like substance.

Such additives and dispersants are known in principle to those skilled in the art. Preference is here given to polyethylene glycols, in particular polyethylene glycol ethers. The products marketed under the trade name Brij by Fluka, Germany, may be mentioned by way of example.

As mentioned at the outset, the composition of the modeling material can, according to the invention, be adjusted within wide limits. However, compositions which achieve particular success according to the invention will be defined below.

Thus, particular mention may be made of embodiments in which the proportion of the first component (metal/metal compound and, if desired, glass-ceramic, glass and/or oxide ceramic) is from 30% by volume to 80% by volume, based on the total volume of the material. Within this range, proportions of from 50% by volume to 75% by volume are particularly preferred.

Preference is likewise given to embodiments in which the first component present in the modeling material comprises, based on the total volume of this first component, from 1% by volume to 100% by volume of titanium nitride and from 0% by volume to 99% by volume of glass-ceramic, glass and/or oxide ceramic. Within these ranges, preference is given to embodiments in which the first component either comprises from 3% by volume to 25% by volume of titanium nitride and accordingly from 75% by volume to 97% by volume of aluminum oxide or comprises from 40% by volume to 99% by volume of titanium nitride and accordingly from 1% by volume to 60% by volume of glass-ceramic or glass.

Mention should also be made of preferred particle sizes of the metal compound and the added materials. Thus, the preferred particle size d₅₀ of the metal compound, in particular the titanium nitride, is from 0.5 μm to 8 μm. Within this range, particularly preferred particle sizes d₅₀ are in the range from 0.5 to 1.5 μm or from 2 to 8 μm. The preferred particle size d₅₀ of the oxide-ceramic material, in particular the aluminum oxide, is from 3 to 5 μm, in particular from 3.5 to 4 μm. The preferred particle size d₅₀ of the glass or the glass ceramic is less than 80 μm, in particular less than 30 μm.

If a first group of further preferred embodiments is to be specified, then particular mention should be made of modeling materials in which the first component comprises, based on the total volume of this first component, either from 1% by volume to 12% by volume of titanium nitride, in particular from 3% by volume to 12% by volume of titanium nitride, having a particle size d₅₀ of from 2 to 8 μm and from 88% by volume to 99% by volume of aluminum oxide, preferably from 88% by volume to 97% by volume of aluminum oxide, having a particle size d₅₀ of from 3 to 5 μm or from 40% by volume to 60% by volume of titanium nitride having a particle size d₅₀ of from 2 to 8 μm and from 40% by volume to 60% by volume of glass or glass-ceramic having a particle size d₅₀ of less than 30 μm.

If a second group of further preferred embodiments is to be specified, then particular mention should be made of modeling materials in which the first component comprises, based on the total volume of this first component, either from 10% by volume to 25% by volume of titanium nitride having a particle size d₅₀ of from 0.5 to 1.5 μm and from 75% by volume to 90% by volume of aluminum oxide having a particle size d₅₀ of from 3 to 5 μm or from 70% by volume to 95% by volume of titanium nitride having a particle size d₅₀ of from 0.5 to 1.5 μm and from 5% by volume to 30% by volume of glass or glass-ceramic having a particle size d₅₀ of less than 30 μm.

With regard to the composition of the modeling material of the invention in respect of the additive which is added, the amounts of this are based on the (total) particle surface area of metal/metal compound and, if used, of glass-ceramic, glass and/or oxide ceramic. Amounts of additive of from about 0.5 to 10 mg, preferably from 1 to 4 mg, per m² of particle surface area may be mentioned here.

As indicated above, the expandability of the modeling material of the invention can be varied within wide limits by choice of the composition. Normally, a linear expandability of the material of from 3 to 50%, in particular from 5 to 30%, will be set to compensate for a sintering shrinkage which usually occurs. Within this range, preference is given to a linear expandability of from 10% to 25% to compensate for usual sintering shrinkages of dental ceramics. As mentioned above, the expansion occurring due to the reaction of the metal/metal compound can be reduced and thus set by addition of the materials mentioned. The latter are inert in the reaction and do not expand. Thus, for example, the (calculated) linear expansion of titanium nitride (TiN) in the oxidation to titanium dioxide (TiO₂) is 18.1%, which can be reduced by addition of glass-ceramic, glass and/or oxide-ceramic materials.

In this context, a further effect occurring in the case of the modeling material of the invention can be utilized. Thus, titanium nitride expands in the reaction to form titanium dioxide not only by the value indicated above but also to a much greater degree. This can be attributed to the fact that there is an increase in the porosity in addition to the chemical reaction indicated above. This “superexpansion” enables a modeling material according to the invention having an expandability of, for example, 30% or even above to be provided. A reduction in the expansion can be achieved by mixing in preferably relatively large amounts of the abovementioned (inert) materials. This makes it possible to set, for example, the preferred values for the linear expandability of from 10 to 25%. The opportunity of reducing the volume expansion by mixing in relatively large amounts of glass-ceramic, glass and/or oxide-ceramic material has the advantage that dental models having high strengths can be obtained. In addition, the microstructure of the dental model can be adjusted. The remaining (open) porosity of the dental model produced using the modeling material of the invention also has the advantage that it can be utilized for introduction of gasses or liquids or for their removal (e.g. during drying).

The modeling material can be stored for a very long time, in particular below its solidification point, i.e. in the solidified state, since no demixing of the components can take place. The modeling material is preferably provided in the form of granules, in particular in the form of largely droplet-shaped granules. In this way, the material can, particularly when used for its intended purpose, be metered in a simple fashion, for example by weighing. To make it possible to achieve the corresponding customary weighing accuracies here, the diameter of the abovementioned granules is preferably in the range from 2 to 20 mm, in particular from 5 to 15 mm. A final point which should be made in this context is that the modeling material of the invention can be present in a packaging means which can be closed, preferably closed in an airtight fashion, or a corresponding container.

The invention further provides a process for preparing the modeling material of the invention. Here, a first component comprising at least one metal and/or at least one metal compound which can react chemically with one another and/or with at least one further reactant so as to lead to an increase in volume, if desired after addition of at least one glass-ceramic, a glass and/or an oxide-ceramic material, is dispersed with a second component comprising at least one substance having thermoplastic and/or wax-like properties, if desired after addition of at least one additive. The procedure described has the advantage that very good interaction of the constituents of the material is achieved by use of the two components. In this context, attention may be drawn to the examples below in which this procedure is described in more detail.

In addition, the invention encompasses the use of the modeling material of the invention for producing shaped dental parts, in particular all-ceramic shaped dental parts, i.e. ones in which the shaped part is made up entirely of ceramic material. In this use according to the invention, the sintering shrinkage occurring on sintering of a green ceramic body formed on a working model is at least partly compensated by the expansion of the modeling material (in the production of the working model). The sintering shrinkage is preferably fully compensated, so that the shaped dental part obtained after sintering has dimensions which correspond exactly to the preparation in the mouth or a prosthetic buildup part.

Finally, the invention provides a process for producing a dental model. In this process, the modeling material of the invention is introduced into a negative mold of a tooth preparation or of a prosthetic buildup part and a chemical reaction which proceeds with an increase in volume of the material is initiated and carried out.

In accordance with what has been said above about the modeling material itself, the process of the invention is further characterized in that the chemical reaction is an oxidation, preferably an oxidation by means of oxygen (or in particular atmospheric oxygen) as further reactant.

In all specified embodiments of the process of the invention, the chemical reaction is preferably initiated and carried out by means of a thermal treatment. Basically, it is possible to employ temperatures within a broad temperature range, with a thermal treatment at temperatures in the range from 200° C. to 1250° C. being preferred. This applies, by way of example and in particular, to cases in which an oxidation of the modeling material in air, i.e. by means of atmospheric oxygen, is carried out.

The features described and further features of the invention can be derived from the description of the examples below in conjunction with the subordinate claims. The individual features can be realized alone or in combination with one another.

### EXAMPLE 1

104.24 g of aluminum oxide (particle size d₅₀=3.8 μm) and 15.76 g of titanium nitride (particle size d₅₀=6.4 μm) are milled together in a planetary mill for about 4 hours (component 1). This corresponds to a volume ratio of 90% of aluminum oxide to 10% of titanium nitride. Ethanol is used as dispersion medium for milling and aluminum oxide milling pots and balls are employed. The mixture is subsequently dried at 80-100° C. 16.63 g of paraffin (solidification point: 62-64° C.) and 0.79 g of Brij 72® are melted in a vessel heated to 85° C. (component 2). While stirring, the likewise heated powder mixture (component 1) is slowly added thereto. A high-speed stirrer disk having a diameter of 50 mm is used for stirring and the mixture is dispersed at about 2000 rμm for 1 hour. This gives a homogeneous, paste-like composition which can be used for molding immediately. The composition can be stored in the solidified state, for which purpose it is divided into droplet-shaped granules having a diameter of 5-15 mm. Before further use, the desired amount has to be metered, heated to 80° C. and redispersed by stirring.

The molds comprise a silicone rubber which have been heated to about 80° C. before being filled with the composition described here. To fill the molds, they are placed on a vibrator and the flowable composition is introduced into the mold, with inclusion of air being avoided. Vibration aids filling of the mold and outgassing of the composition. After cooling, the shaped body consisting of the composition according to the invention is demolded.

This shaped part is embedded in a bed of aluminum oxide powder and dewaxed and oxidized in a suitable oven. The following temperature profile is used for this purpose:

Heat at 0.5 K/min from room temperature to 200° C. and hold for 2 hours, heat at 0.5 K/min to 250° C. and hold for 1 hour, heat at 2 K/min to 1200° C. and hold for 2 hours, allow to cool. The linear expansion achieved is 18%.

### EXAMPLE 2

89.54 g of aluminum oxide (particle size d₅₀=3.8 μm) and 30.46 g of titanium nitride (particle size d₅₀=1.2 μm) are milled together in a planetary mill for about 4 hours (component 1). This corresponds to a volume ratio of 80% of aluminum oxide to 20% of titanium nitride. Ethanol is used as dispersion medium for milling and aluminum oxide milling pots and balls are employed. The mixture is subsequently dried at 80-100° C. 16.09 g of paraffin (solidification point: 62-64° C.) and 0.74 g of Brij 72® are melted in a vessel heated to 85° C. (component 2). While stirring, the likewise heated powder mixture (component 1) is slowly added thereto. A high-speed stirrer disk having a diameter of 50 mm is used for stirring and the mixture is dispersed at about 2000 rμm for 1 hour. This gives a homogeneous, paste-like composition which can be used for molding immediately. The composition can be stored in the solidified state, for which purpose it is divided into droplet-shaped granules having a diameter of 5-15 mm. Before further use, the desired amount has to be metered, heated to 80° C. and redispersed by stirring.

The molds comprise a silicone rubber which have been heated to about 80° C. before being filled with the composition described here. To fill the molds, they are placed on a vibrator and the flowable composition is introduced into the mold, with inclusion of air being avoided. Vibration aids filling of the mold and outgassing of the composition. After cooling, the shaped body consisting of the composition according to the invention is demolded.

This shaped part is embedded in a bed of aluminum oxide powder and dewaxed and oxidized in a suitable oven. The following temperature profile is used for this purpose:

Heat at 0.5 K/min from room temperature to 200° C. and hold for 2 hours, heat at 0.5 K/min to 250° C. and hold for 1 hour, heat at 2 K/min to 1200° C. and hold for 2 hours, allow to cool. The linear expansion achieved is 11.5%.

### EXAMPLE 3

134.52 g of glass-ceramic powder (composition in % by mass: 57.8 SiO₂, 13.8 Al₂O₃, 10.4 Na₂O, 8.7 K₂O, 4.3 CaO, 1.9 SnO₂, 1.7 ZnO₂, 0.6 B₂O₃, 0.2 ZrO₂; glass transformation point: 550° C., softening point: 620° C., CTE: 12.7×10⁻⁶; proportion of leucite: 20-30%; particle size: d₉₀<10 μm) and 15.48 g of titanium nitride (particle size: d₅₀=1.2 μm) are added to about 100 ml of ethanol and the suspension is dispersed by means of an ultrasonic disintegrator. All of the ethanol is subsequently taken off. This powder mixture (component 1) has a volume ratio of 80% by volume of glass-ceramic to 20% by volume of titanium nitride. 15.08 g of paraffin (solidification point: 62-64° C., and 2 g of Brij 72® are melted in a vessel heated to 85° C. (component 2). While stirring, the likewise heated powder mixture (component 1) is slowly added thereto. A propeller stirrer having a diameter of 50 mm is used for stirring and the powder mixture is stirred in at about 500 rμm and the mixture is subsequently dispersed at about 1000 rμm for 1 hour. This gives a homogeneous, paste-like composition which is degassed by application of a vacuum (<10 mbar) and can be used for molding immediately. The composition can be stored in the solidified state, for which purpose it is divided into droplet-shaped granules having a diameter of 5-15 mm. Before further use, the desired amount has to be metered, heated to 85° C. and redispersed by stirring.

The molds comprise a silicone rubber which have been heated to about 85° C. before being filled with the composition described here. To fill the molds, they are placed on a vibrator and the flowable composition is introduced into the molds. The filled molds are then evacuated. Vibration and evacuation aids filling of the mold and outgassing of the composition. After cooling, the shaped body consisting of the composition according to the invention is demolded.

These shaped parts are embedded in a bed of aluminum oxide powder and dewaxed and oxidized in a suitable oven. The following temperature profile is used for this purpose:

Heat at 1 K/min from room temperature to 100° C., continue at 2 K/min to 400° C., at 0.5 K/min to 420° C., at 0.4 K/min to 550° C. and at 4 K/min to a final temperature of 750° C. which is held for 30 minutes. The linear expansion achieved is 16.6%.

1. A modeling material for dental purposes, characterized in that it comprises, preferably as a first component, at least one metal and/or at least one metal compound which are able to react chemically with one another and/or with at least one further reactant so as to lead to an increase in volume and, preferably as second component, at least one substance having thermoplastic and/or wax-like properties.

2. The modeling material as claimed in claim 1, characterized in that an increase in the oxidation number of the metal or of the metal of the metal compound occurs in the chemical reaction.

3. The modeling material as claimed in claim 1, characterized in that the further reactant is an oxygen-containing compound or preferably oxygen.

4. The modeling material as claimed in claim 1, characterized in that the metal or the metal of the metal compound is a transition metal.

5. The modeling material as claimed in claim 4, characterized in that the metal or the metal of the metal compound is a transition metal of the fourth transition group, in particular titanium.

6. The modeling material as claimed in claim 1, characterized in that the metal compound is a compound of a metal with a nonmetal, preferably a nitride, a carbide or a boride, in particular a nitride.

7. The modeling material as claimed in claim 1, characterized in that the substance is a wax, preferably at least one paraffin wax.

8. The modeling material as claimed in claim 1, characterized in that it has a solidification point in the range from 50° to 80° C., preferably from 55° to 70° C.

9. The modeling material as claimed in claim 1, characterized in that it further comprises, preferably as constituent of the first component, at least one glass and/or a glass-ceramic.

10. The modeling material as claimed in claim 9, characterized in that the glass is a silicate glass or the glass-ceramic is derived from silicate glass.

11. The modeling material as claimed in claim 1, characterized in that it further comprises, preferably as constituent of the first component, at least one oxide-ceramic material.

12. The modeling material as claimed in claim 11, characterized in that the oxide-ceramic material is aluminum oxide.

13. The modeling material as claimed in claim 1, characterized in that it further comprises at least one additive, in particular at least one dispersant.

14. The modeling material as claimed in claim 13, characterized in that the additive is at least one polyethylene glycol, preferably at least one polyethylene glycol ether.

15. The modeling material as claimed in claim 1, characterized in that the proportion of the first component is, based on the total volume of the material, from 30% by volume to 80% by volume, preferably from 50% by volume to 75% by volume.

16. The modeling material as claimed in claim 1, characterized in that the first component present in the modeling material comprises, based on the total volume of this first component, either from 1% by volume to 100% by volume of titanium nitride, preferably from 3% by volume to 25% by volume of titanium nitride, and from 0% by volume to 99% by volume of oxide-ceramic material, in particular aluminum oxide, preferably from 75% by volume to 97% by volume of oxide-ceramic material, in particular aluminum oxide, or from 1% by volume to 100% by volume of titanium nitride, preferably from 40% by volume to 99% by volume of titanium nitride, and from 0% by volume to 99% by volume of glass or glass-ceramic, preferably from 1% by volume to 60% by volume of glass or glass-ceramic.

17. The modeling material as claimed in claim 16, characterized in that the particle size d₅₀ of the metal compound, in particular the titanium nitride, is from 0.5 μm to 8 μm, preferably from 0.5 to 1.5 μm or from 2 to 8 μm.

18. The modeling material as claimed in claim 16, characterized in that the particle size d₅₀ of the oxide-ceramic material, in particular the aluminum oxide, is from 3 to 5 μm, preferably from 3.5 to 4 μm, or the particle size of d₅₀ of the glass or the glass-ceramic is less than 80 μm, preferably less than 30 μm.

19. The modeling material as claimed in claim 1, characterized in that the first component present in the modeling material comprises, based on the total volume of this first component, either from 1% by volume to 12% by volume of titanium nitride, in particular from 3% by volume to 12% by volume of titanium nitride, having a particle size d₅₀ of from 2 to 8 μm and from 88% by volume to 99% by volume of aluminum oxide, preferably from 88% by volume to 97% by volume of aluminum oxide, having a particle size d₅₀ of from 3 to 5 μm or from 40% by volume to 60% by volume of titanium nitride having a particle size d₅₀ of from 2 to 8 μm and from 40% by volume to 60% by volume of glass or glass-ceramic having a particle size of d₅₀ of less than 80 μm, preferably less than 30 μm.

20. The modeling material as claimed in claim 1, characterized in that the first component present in the modeling material comprises, based on the total volume of this first component, either from 10% by volume to 25% by volume of titanium nitride having a particle size d₅₀ of from 0.5 to 1.5 μm and from 75% by volume to 90% by volume of aluminum oxide having a particle size of d₅₀ of from 3 to 5 μm or from 70% by volume to 95% by volume of titanium nitride having a particle size d₅₀ of from 0.5 to 1.5 μm and from 5% by volume to 30% by volume of glass or glass-ceramic having a particle size d₅₀ of less than 80 μm, preferably less than 30 μm.

21. The modeling material as claimed in claim 13, characterized in that the additive is present in an amount based on the particle surface area of metal and/or metal compound and, if present, glass, glass-ceramic and/or oxide-ceramic material of from about 0.5 to 10 mg, preferably from 1 to 4 mg, per m² of particle surface area.

22. The modeling material as claimed in claim 1, characterized in that the linear expandability of the material is in the range from 3 to 50%, preferably from 5 to 30%, in particular from 10 to 25%.

23. The modeling material as claimed in claim 1, characterized in that it is in the form of granules, preferably in the form of largely droplet-shaped granules.

24. The modeling material as claimed in claim 23, characterized in that the diameter of the granules is in the range from 2 to 20 mm, preferably from 5 to 15 mm.

25. The modeling material as claimed in claim 1, characterized in that it can be stored in the solidified state, in particular in packaging which can be closed in an airtight fashion.

26. A process for preparing the modeling material as claimed in claim 1, characterized in that a first component comprising at least one metal and/or at least one metal compound which can react chemically with one another and/or with at least one further reactant so as to lead an increase in volume, if desired after addition of at least one glass-ceramic, a glass and/or an oxide-ceramic material, is dispersed with a second component comprising at least one wax, if desired after addition of at least one additive.

27. The use of the modeling material as claimed in claim 1 for producing preferably all-ceramic shaped dental parts, wherein the sintering shrinkage occurring on sintering of a green ceramic body formed on a working model is at least partly, preferably completely, compensated by the expansion of the modeling material in the production of the working model.

28. A process for producing a dental model, in particular a working model, characterized in that the modeling material as claimed in claim 1 is introduced into a negative mold of a tooth preparation or of a prosthetic buildup part and a chemical reaction which proceeds with an increase in volume of the material in initiated and carried out.

29. The process as claimed in claim 28, characterized in that the reaction is an oxidation, preferably an oxidation by means of oxygen, in particular atmostpheric oxygen, as further reactant.

30. The process as claimed in claim 28, characterized in that the reaction is initiated and carried out by means of a thermal treatment which is preferably carried out at temperatures in the range from 200° C. to 1250° C.
